(19) United States
(12) Patent Application Publication
(10) Pub. No.: US 2026/0209511 A1
(43) Pub. Date: Jul. 23, 2026

(54) RESIN COMPOSITION AND USE FOR SAME

(71) Applicant: KANEKA CORPORATION, Osaka-shi (JP)

(72) Inventors: Takenobu SUNAGAWA, Settsu-shi (JP); Takeshi SUGIYAMA, Settsu-shi (JP); Shun MURASAWA, Settsu-shi (JP)

(73) Assignee: KANEKA CORPORATION, Osaka-shi (JP)

(21) Appl. No.: 19/568,998

(22) Filed: Mar. 17, 2026

Related U.S. Application Data
(63) Continuation of application No. PCT/JP2024/035547, filed on Oct. 4, 2024.

(30) Foreign Application Priority Data
Oct. 4, 2023 (JP) 2023-172666

(51) Int. Cl. C08L 67/04; C08J 5/18

(52) U.S. Cl. CPC C08L 67/04; C08J 5/18; C08J 2367/04; C08J 2467/04; C08L 2203/16; C08L 2205/025

(57) ABSTRACT

An object is to provide a resin composition that can provide a molded product having excellent impact resistance. The object is attained by a resin composition containing: a P3HA-based resin component (A) that contains a P3HA-based copolymer (a-1) having a weight average molecular weight of 450,000 to 1,000,000 and a P3HA-based copolymer (a-2) having a weight average molecular weight greater by 100,000 or more than that of (a-1); and inorganic particles (B).

### TECHNICAL FIELD

The present invention relates to a resin composition and use thereof.

### BACKGROUND ART

Conventionally, a technique of adding various modifiers (for example, crosslinked particles) to a thermoplastic resin in order to improve the mechanical strength, such as impact strength, of the thermoplastic resin has been known.

As crosslinked resin particles, for example, crosslinked resin particles constituted by a resin such as an acrylic resin, an acrylic-silicone-based resin, or polystyrene are known (for example, Patent Literatures 1 and 2, etc.).

In recent years, development of resins having biodegradability (hereinafter may be referred to as “biodegradable resins”) has been actively pursued from the viewpoint of consideration for the environment at the time of disposal and after disposal of resin products. For example, Patent Literature 1 discloses a thermoplastic resin composition that contains poly(3-hydroxybutyrate-co-3-hydroxyhexanoate), which is a type of biodegradable resin, that is biodegradable, and that has excellent environmental compatibility.

### CITATION LIST

### Patent Literature

### [Patent Literature 1]

Japanese Patent Application Publication No. 2004-161802

### SUMMARY OF INVENTION

### Technical Problem

However, conventional resin compositions, such as the resin composition disclosed in Patent Literature 1, have room for improvement from the viewpoint of the impact resistance of molded products obtained by molding the resin compositions.

An embodiment of the present invention has been made in view of the above-described current situation, and an object thereof is to provide a resin composition that can provide a molded product having excellent impact resistance.

### Solution to Problem

In order to attain the above-described object, an embodiment of the present invention includes the following configuration:
a resin composition containing a poly(3-hydroxyalkanoate)-based resin component (A) and inorganic particles (B), wherein the poly(3-hydroxyalkanoate)-based resin component (A) contains a poly(3-hydroxyalkanoate)-based copolymer (a-1) having a weight average molecular weight of 450,000 to 1,000,000 and a poly(3-hydroxyalkanoate)-based copolymer (a-2) having a weight average molecular weight greater by 100,000 or more than that of the poly(3-hydroxyalkanoate)-based copolymer (a-1).

### Advantageous Effects of Invention

An embodiment of the present invention has the effect that it is possible to provide a resin composition that can provide a molded product having excellent impact resistance.

### DESCRIPTION OF EMBODIMENTS

The following description will discuss embodiments of the present invention. The present invention is not, however, limited to these embodiments. The present invention is not limited to the configurations described below, but may be altered in various ways within the scope of the claims. The present invention also encompasses, in its technical scope, any embodiment or example derived by combining technical means disclosed in differing embodiments or examples. Further, it is possible to form a new technical feature by combining technical means disclosed in any embodiments. All academic and patent documents cited in the present specification are incorporated herein by reference. Any numerical range expressed as “A to B” in the present specification is intended to mean “not less than A and not more than B (i.e., a range from A to B which includes both A and B)” unless otherwise stated.

### 1. Resin Composition

A resin composition in accordance with an embodiment of the present invention is a resin composition containing a poly(3-hydroxyalkanoate)-based resin component (A) and inorganic particles (B), wherein the poly(3-hydroxyalkanoate)-based resin component (A) contains a poly(3-hydroxyalkanoate)-based copolymer (a-1) having a weight average molecular weight of 450,000 to 1,000,000 and a poly(3-hydroxyalkanoate)-based copolymer (a-2) having a weight average molecular weight greater by 100,000 or more than that of the poly(3-hydroxyalkanoate)-based copolymer (a-1).

In the present specification, the “poly(3-hydroxyalkanoate)-based resin” may be referred to as “P3HA-based resin”, the “poly(3-hydroxyalkanoate)-based copolymer” may be referred to as “P3HA-based copolymer”, and the “resin composition in accordance with an embodiment of the present invention” may be referred to as “the present resin composition”.

The inventors of the present invention found, through diligent studies on resin compositions containing P3HA-based resins, that using a mixture of two types of P3HA-based resins (copolymers) having different molecular weights as a P3HA-based resin component makes it possible to improve the impact resistance of a resulting molded product. As a result, the inventors of the present invention completed the present invention. The inventors of the present invention also found that further blending inorganic particles into this resin composition can improve the elastic modulus of the resulting molded product.

Since the present resin composition contains P3HA-based resins, which are each a biodegradable plastic, the present resin composition has biodegradability. Therefore, the present resin a resin composition is expected to be useful as composition and a molded product that are friendly to the global environment and that can address, for example, problems of plastic waste. More specifically, an embodiment of the present invention makes it possible to provide a biodegradable resin composition or molded product, and consequently makes it possible to prevent soil pollution and/or marine pollution when these are disposed of. That is, an embodiment of the present invention is expected to contribute to achievement of the Sustainable Development Goals (SDGs), such as, for example, Goal 12 “Ensure sustainable consumption and production patterns” and/or Goal 14 “Conserve and sustainably use the oceans, seas and marine resources for sustainable development”.

Each component that can be contained in the present resin composition is described below in detail.

### (P3HA-Based Resin Component (A))

The present resin composition contains a P3HA-based resin component (A). Hereinafter, the “P3HA-based resin component (A)” may be referred to as “component (A)”. It can also be said that the component (A) is a matrix resin in the present resin composition.

The component (A) is a composition that contains a poly(3-hydroxyalkanoate)-based copolymer (a-1) having a weight average molecular weight of 450,000 to 1,000,000 and a poly(3-hydroxyalkanoate)-based copolymer (a-2) having a weight average molecular weight greater by 100,000 or more than that of the poly(3-hydroxyalkanoate)-based copolymer (a-1). Hereinafter, the “poly(3-hydroxyalkanoate)-based copolymer (a-1)” may be referred to as “copolymer (a-1)”, and hereinafter, the “poly(3-hydroxyalkanoate)-based copolymer (a-2)” may be referred to as “copolymer (a-2)”. The component (A) only needs to be a composition that contains at least two types of P3HA-based resins, i.e., the copolymer (a-1) and the copolymer (a-2), and may be a composition that is constituted only by the two types of P3HA-based resins, i.e., the copolymer (a-1) and the copolymer (a-2), or may be a composition that contains another P3HA-based resin in addition to the polymer (a-1) and the copolymer (a-2).

A P3HA-based resin is a polymer containing, as an essential repeating unit (hereinafter, the “repeating unit” may be simply referred to as “unit”), a 3-hydroxyalkanoate repeating unit represented by a formula: [—CHR—CH₂—CO—O—] (in the formula, R is an alkyl group represented by CₙH₂ₙ₊₁, and n is an integer of 1 or more but 15 or less). Each P3HA-based resin may be a copolymer constituted by (i) two or more types of 3-hydroxyalkanoate repeating units or (ii) a 3-hydroxyalkanoate repeating unit and another repeating unit. In the present specification, the “P3HA-based resin” is intended to mean a polymer (copolymer) containing a 3-hydroxyalkanoate repeating unit at a ratio of 50 mol % or more with respect to all monomer repeating units (100 mol %). In other words, the copolymer (a-1) and the copolymer (a-2) are each a copolymer containing a 3-hydroxyalkanoate repeating unit at a ratio of 50 mol % or more with respect to all monomer repeating units (100 mol %).

The copolymer (a-1) and/or the copolymer (a-2) contains the 3-hydroxyalkanoate repeating unit at a ratio of preferably 60 mol % or more and more preferably 70 mol % or more, with respect to all monomer repeating units (100 mol %).

The P3HA-based resin that is the copolymer (a-1) and/or the copolymer (a-2) is not particularly limited, and may be, for example, a copolymer constituted by two or more types of monomers selected from the group consisting of 3-hydroxybutyrate, 3-hydroxypropionate, 3-hydroxyvalerate, 3-hydroxyhexanoate, 3-hydroxyheptanoate, 3-hydroxyoctanoate, 3-hydroxynonanoate, 3-hydroxydecanoate, 3-hydroxydodecanoate, 3-hydroxydodecenoate, 3-hydroxytetradecanoate, 3-hydroxyhexadecanoate, and 3-hydroxyoctadecanoate. The P3HA-based resin may be a copolymer containing any of the above monomers as a main monomer and further containing, as a comonomer, a hydroxyalkanoate repeating unit (for example, 4-hydroxybutyrate or the like) other than the 3-hydroxyalkanoate repeating unit. In the present specification, a copolymer containing a monomer X as a main monomer and containing a monomer Y as a comonomer may be referred to as “poly(X-co-Y)”. It can also be said that poly(X-co-Y) is a copolymer containing an X repeating unit and a Y repeating unit.

More specific examples of the P3HA-based resin that is the copolymer (a-1) and/or the copolymer (a-2) include poly(3-hydroxybutyrate-co-3-hydroxyhexanoate) (hereinafter may be referred to as “P3HB3HH”), poly(3-hydroxybutyrate-co-4-hydroxybutyrate), poly(3-hydroxybutyrate-co-3-hydroxypropionate), poly(3-hydroxybutyrate-co-3-hydroxyvalerate), poly(3-hydroxybutyrate-co-3-hydroxyoctanoate), poly(3-hydroxybutyrate-co-3-hydroxyoctadecanoate), poly(3-hydroxybutyrate-co-3-hydroxydecanoate), and poly(3-hydroxybutyrate-co-3-hydroxyvalerate-co-3-hydroxyhexanoate). The copolymer (a-1) and the copolymer (a-2) may be the same type of P3HA-based resins or different types of P3HA-based resins. As the copolymer (a-1) and/or the copolymer (a-2), two or more types of P3HA-based resins may be used.

Among P3HA-based resins, the copolymer (a-1) and/or the copolymer (a-2) is preferably a copolymer containing a 3-hydroxyalkanoate repeating unit in which R in the above formula is an alkane having one carbon atom, i.e., a 3-hydroxybutyrate (3HB) repeating unit, and another hydroxyalkanoate repeating unit, because such a copolymer is a resin which can be industrially produced by a microorganism with use of a plant raw material and which can contribute to resource recycling (carbon neutrality) and thus has a lower environmental load.

In a case where the copolymer (a-1) and/or the copolymer (a-2) is a copolymer containing a 3HB repeating unit, the composition ratio of the 3HB repeating unit (content ratio of the 3HB repeating unit) is preferably 77 mol % to 99 mol %, more preferably 80 mol % to 97 mol, still more preferably 85 mol % to 95 mol %, and particularly preferably 87 mol % to 92 mol %, with respect to all monomer repeating units (100 mol %), from the viewpoint of the balance between flexibility and strength. In a case where the composition ratio of the 3HB repeating unit in the copolymer (a-1) and/or the copolymer (a-2) is within the above range, there is an advantage that it is possible to provide a molded product that has both flexibility and strength (rigidity) and that has improved productivity. In particular, in a case where the composition ratio of the 3HB repeating unit in the copolymer (a-2) is 87 mol % to 92 mol %, an impact resistance improving effect brought about by the copolymer (a-2) being contained tends to be further improved. Even in a case where the content of the copolymer (a-2) in the resin composition is relatively small, it is possible to realize sufficient impact resistance. Note that the monomer composition ratio in a copolymer that is a P3HA-based resin can be measured by gas chromatography or the like (see, for example, International Publication No. WO 2014/020838). As the copolymer (a-1) and/or the copolymer (a-2), copolymers having the same composition ratio of the 3HB repeating unit may be used, or two or more types of copolymers having different composition ratios may be used in combination.

The P3HA-based resin can be produced by a microorganism. The microorganism that produces the P3HA-based resin is not particularly limited, provided that the microorganism has the ability to produce the P3HA-based resin. For example, as P3HB-producing bacteria, Bacillus megaterium, which was first discovered in 1925, is known, and, in addition, natural microorganisms such as Cupriavidus necator (previously classified as Alcaligenes eutrophus), Ralstonia eutropha, and Alcaligenes latus are known. In these microorganisms, P3HB is accumulated within bacterial cells thereof.

As bacteria that produce a copolymer of a 3HB repeating unit and another hydroxyalkanoate repeating unit, Aeromonas caviae, which is a P3HB3HH-producing bacterium, and the like are known. In particular, Alcaligenes eutrophus AC32 (FERM BP-6038) (T. Fukui, Y. Doi, J. Bacteriol., 179, pp. 4821-4830 (1997)), into which genes of P3HA synthetases have been introduced in order to increase the productivity of P3HB3HH, is preferable. Bacterial cells of such a microorganism which has been cultured under an appropriate condition so that a P3HA-based resin is accumulated in the bacterial cells are used. In addition to the above, depending on a desired P3HA-based resin, a genetically modified microorganism into which various genes associated with synthesis of P3HA have been introduced may be used, and a culture condition including the type of a substrate may be optimized.

The weight average molecular weight of the copolymer (a-1) is preferably 450,000 to 1,000,000, more preferably 500,000 to 900,000, and still more preferably 550,000 to 800,000. In a case where the weight average molecular weight of the copolymer (a-1) is within the above range, there is an advantage that it is possible to provide a molded product having excellent toughness. The weight average molecular weight of the copolymer (a-2) is not particularly limited, provided that the weight average molecular weight is greater by 100,000 or more than the weight average molecular weight of the copolymer (a-1). The weight average molecular weight of the copolymer (a-2) is, for example, preferably 550,000 to 3,000,000, more preferably 600,000 to 2,000,000, and still more preferably 70,000 to 1,500,000. By mixing the copolymer (a-1) and the copolymer (a-2), which has a relatively large weight average molecular weight, it is possible to improve the impact resistance of a resulting molded product. In particular, in a case where the weight average molecular weight of the copolymer (a-2) is within the above range, there is an advantage that it is possible to provide a molded product that also has excellent impact resistance while having sufficient processability.

In the present specification, the weight average molecular weights of the P3HA-based resins (i.e., the copolymer (a-1) and the copolymer (a-2)) are each a value measured by a gel permeation chromatography (GPC) method, and are, for example, each a value measured in terms of polystyrene with use of a “High-performance liquid chromatograph 20A system” manufactured by Shimadzu Corporation, with a polystyrene gel (for example, “K-G 4A”, “K-806M”, or the like manufactured by Showa Denko K.K.) for a column and chloroform for a mobile phase. In the above measurement, a calibration curve obtained by measuring, by GPC, polystyrenes for which molecular weights are known can be used, and, in this case, the calibration curve can be created with use of polystyrenes having weight average molecular weights of 31,400, 197,000, 668,000, and 1, 920,000. As a column in the GPC at the time of creation of the calibration curve, a column suitable for measuring the molecular weight of polystyrene may be used.

The content of the copolymer (a-1) in the component (A) is not particularly limited, but is preferably 60 parts by weight to 99 parts by weight, more preferably 70 parts by weight to 97 parts by weight, and still more preferably 80 parts by weight to 95 parts by weight, with respect to 100 parts by weight of the component (A). In particular, by setting the content of the copolymer (a-1) in 100 parts by weight of the component (A) to 60 parts by weight to 99 parts by weight and preferably 80 parts by weight to 95 parts by weight, it is possible to further improve the elastic modulus of a resulting molded product, and also it is possible to provide a resin composition having a relatively low melt viscosity and excellent molding processability. The content of the copolymer (a-1) in the component (A) may be 1 part by weight to 40 parts by weight, may be 3 parts by weight to 30 parts by weight, and may be 5 parts by weight to 20 parts by weight. The content of the copolymer (a-2) in the component (A) also not particularly limited, but may be 1 part by weight to 99 parts by weight, may be 20 parts by weight to 99 parts by weight, may be 40 parts by weight to 99 parts by weight, is preferably 60 parts by weight to 99 parts by weight, more preferably 70 parts by weight to 97 parts by weight, and still more preferably 80 parts by weight to 95 parts by weight. In particular, by setting the content of the copolymer (a-2) in 100 parts by weight of the component (A) to 70 parts by weight to 97 parts by weight, it is possible to further improve the impact resistance of a resulting molded product. The content of the copolymer (a-2) in the component (A) may be 1 part by weight to 40 parts by weight, may be 3 parts by weight to 30 parts by weight, and may be 5 parts by weight to 20 parts by weight.

As described above, from the viewpoint of further improving the elastic modulus of a resulting molded product and from the viewpoint of providing a resin composition having a relatively low melt viscosity and excellent molding processability, it is preferable to increase the content ratio of the copolymer (a-1) in the component (A). From the viewpoint of further improving the impact resistance of a resulting molded product, it is preferable to increase the content ratio of the copolymer (a-2) in the component (A). Therefore, in the present resin composition, it is preferable to adjust, as appropriate, the content ratios of the copolymer (a-1) and the copolymer (a-2) in the resin composition in accordance with physical properties desired for a resulting molded product.

In a case where the content of the copolymer (a-1) in 100 parts by weight of the component (A) is 60 parts by weight to 99 parts by weight, that is, in a case where the content ratio of the copolymer (a-2) in the component (A) is relatively low, it is preferable for the present resin composition to use, as the copolymer (a-2), a copolymer which contains a 3-hydroxybutyrate (3HB) repeating unit and another hydroxyalkanoate repeating unit, in which the composition ratio of the 3HB repeating unit is 87 mol % to 92 mol %, and which has a higher impact resistance improving effect, from the viewpoint of further improving the impact resistance of a resulting molded product. That is, the resin composition in accordance with a preferable embodiment of the present invention includes the following configuration: a resin composition containing a poly(3-hydroxyalkanoate)-based resin component (A) and inorganic particles (B), wherein: the poly(3-hydroxyalkanoate)-based resin component (A) contains a poly(3-hydroxyalkanoate)-based copolymer (a-1) having a weight average molecular weight of 450,000 to 1,000,000 and a poly(3-hydroxyalkanoate)-based copolymer (a-2) having a weight average molecular weight greater by 100,000 or more than that of the poly(3-hydroxyalkanoate)-based copolymer (a-1); a content of the poly(3-hydroxyalkanoate)-based copolymer (a-1) in 100 parts by weight of the poly(3-hydroxyalkanoate)-based resin component (A) is 60 parts by weight to 99 parts by weight; the poly(3-hydroxyalkanoate)-based copolymer (a-2) is a copolymer of a 3-hydroxybutyrate unit and another hydroxyalkanoate unit; and a composition ratio of the 3-hydroxybutyrate unit is 87 mol % to 92 mol %.

According to the above configuration, it is possible to provide a molded product having excellent impact resistance and a high elastic modulus, and it is possible to provide a resin composition having a relatively low melt viscosity and excellent molding processability.

The gel fraction of the component (A) in the present resin composition is not particularly limited, but is preferably less than 50%, more preferably 40% or less, still more preferably 30% or less, may be 20% or less, may be 10% or less, and may be 0%, because moldability becomes good. The gel fraction of the component (A) is affected by the amount of a crosslinked structure of the component (A) (in other words, each P3HA-based resin contained in the component (A)). Specifically, the component (A) having a lower gel fraction means that the amounts of crosslinked structures of the P3HA-based resins contained in the component (A) are smaller. That is, it is preferable that the component (A) in the present resin composition contains P3HA-based resins each having a small amount of crosslinked structure or no crosslinked structure. The gel fraction of each P3HA-based resin that is not crosslinked in a production process is usually 0%.

From the above viewpoint, the gel fractions of the copolymer (a-1) and the copolymer (a-2) are both preferably less than 50%, more preferably 40% or less, still more preferably 30% or less, may be 20% or less, may be 10% or less, and may be 0%. By controlling the gel fraction of each P3HA-based resin (in particular, the copolymer (a-1) and the copolymer (a-2)) contained in the component (A) within the above range, it is also possible to control the gel fraction of the component (A) within a similar range.

In the present specification, the gel fractions of the P3HA-based resins (composition), including the copolymer (a-1) and the copolymer (a-2), are each a value measured by the following method. That is, a dried product of each P3HA-based resin (composition) to be measured is added to chloroform such that the concentration of the P3HA-based resin becomes 0.7% by weight, and dissolved at 60° C. for 30 minutes to obtain a chloroform solution. Thereafter, after the chloroform solution is left to stand at room temperature for 3 hours, the chloroform solution is filtered with use of a membrane filter having a pore diameter of 0.45 μm. During filtration, loss is prevented by carrying out the filtration while sufficiently washing the inside of a container and the filter by pouring chloroform multiple times over the inside of the container and the filter. A gel remaining on the filter is dried, the weight of the gel and the filter is measured, and the gel fraction is calculated by the following formula.

$$gel fraction = ( weight of filter including dried gel - weight of filter only ) / weight of P 3 HA - based \\ resin ( composition ) used in measurement \times 100 ( \% ) \qquad Formula$$

The component (A) may contain a P3HA-based resin (another P3HA-based resin) other than the copolymer (a-1) and the copolymer (a-2). Examples of such another P3HA-based resin include various P3HA-based resins having a weight average molecular weight of less than 450,000.

The content of another P3HA-based resin in the component (A) is not particularly limited, provided that the effects of the present invention are not impaired. However, the content of another P3HA-based resin is preferably 0.1 parts by weight to 10 parts by weight and more preferably 0.5 parts by weight to 5 parts by weight, with respect to 100 parts by weight of the total amount of the component (A).

### (Inorganic Particles (B))

The present resin composition contains inorganic particles (B). Hereinafter, the “inorganic particles (B)” may be referred to as “component (B)”. By the present resin composition containing the component (B), it is possible to improve the elastic modulus of a resulting molded product.

The inorganic particles that are the component (B) are not particularly limited, and known inorganic particles can be used. Among the known inorganic particles, the component (B) is preferably one or more selected from the group consisting of talc, mica, kaolinite, montmorillonite, and smectite, because there is an advantage that it is possible to provide a molded product that also has excellent strength while having sufficient surface smoothness.

The average particle diameter of the inorganic particles that are the component (B) is not particularly limited, but is preferably 1 μm to 50 μm, more preferably 3 μm to 40 μm, and still more preferably 5 μm to 30 μm, because there is an advantage that it is possible to provide a molded product that has more excellent strength while maintaining sufficient surface smoothness. Note that the average particle diameter of the inorganic particles can be measured as a median diameter (D50) with use of a laser diffraction/scattering type device such as “Microtrac MT3100II” manufactured by Nikkiso Co., Ltd.

### (Another Resin)

The present resin composition may contain a resin component (another resin) other than the component (A). Another resin is not particularly limited, provided that another resin is a known thermoplastic resin, that is, a resin that can be molded into a desired shape by being (i) melted by heating and then (ii) cooled and solidified. Examples of another resin include: polyolefin-based resins such as polyethylene and polypropylene; acrylic resins such as polyvinyl chloride, polystyrene, polyvinyl acetate, polyurethane, polytetrafluoroethylene, and polymethyl methacrylate; AS resins; polyamides; polyacetals; polycarbonates; modified polyphenylene ethers; polyester-based resins; and cyclic polyolefins. As another resin, one of these resins may be used solely or two or more of these resins may be used in combination. Another resin can also be a matrix resin in the present resin composition.

Among the above resins used as another resin, polyester-based resins are preferable, and, from the viewpoint of biodegradability, aliphatic polyesters and aliphatic aromatic polyesters other than the P3HA-based resins are preferable.

The aliphatic polyesters that are used as another resin and that are other than the P3HA-based resins are, as for example, PHA-based resins such polyglycolic acid, polycaprolactone, polylactic acid, and poly(4-hydroxyalkanoate)-based resins, or aliphatic polyesters other than PHA, such as polyethylene succinate, polybutylene succinate (hereinafter may be referred to as “PBS”), polyhexamethylene succinate, polyethylene adipate, polybutylene adipate, polyhexamethylene adipate, polybutylene succinate adipate (hereinafter may be referred to as “PBSA”), polyethylene sebacate, and polybutylene sebacate.

Examples of the aliphatic aromatic polyesters that are used as another resin include poly(butylene adipate-co-butylene terephthalate) (PBAT), poly(butylene sebacate-co-butylene terephthalate), poly(butylene azelate-co-butylene terephthalate), and poly(butylene succinate-co-butylene terephthalate) (PBST).

The content of another resin in the present resin composition is not particularly limited, provided that the effects of the present invention are not impaired, but is preferably 1 part by weight to 50 parts by weight, more preferably 3 parts by weight to 30 parts by weight, and still more preferably 5 parts by weight to 10 parts by weight, with respect to 100 parts by weight of the component (A).

### (Another Component)

The present resin composition may further contain another component such as a crystal nucleating agent, a lubricant, a plasticizer, an organic filler, an antioxidant, a hydrolysis inhibitor, an ultraviolet absorber, a colorant such as a dye or a pigment, and an antistatic agent, in addition to the component (A), the component (B), and another resin that is an optional component, provided that the function of a resulting molded product is not impaired.

The present resin composition may further contain a crystal nucleating agent. The crystal nucleating agent is not particularly limited, but examples thereof include: sugar alcohol compounds derived from natural products, such as erythritol, pentaerythritol, galactitol, mannitol, and arabitol; polysaccharides such as chitin and chitosan; polyols such as aliphatic alcohol (polyol), polyvinyl alcohol, and polyethylene oxide; organic carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminum dibenzoate, potassium dibenzoate, lithium dibenzoate, sodium β-naphthalate, and sodium cyclohexanecarboxylate; organic sulfonic acid salts such as sodium p-toluene sulfonate and sodium sulfoisophthalate; carboxylic acid amides such as ethylene bis(stearic acid amide), ethylene bis(lauric acid amide), palmitic acid amide, hydroxystearic acid amide, erucic acid amide, and trimesic acid tris(t-butylamide); carboxylic acid esters such as lauric acid ester, palmitic acid ester, oleic acid ester, stearic acid ester, erucic acid ester, N-oleyl palmitic acid ester, N-oleyl oleic acid ester, N-oleyl stearic acid ester, N-stearyl oleic acid ester, N-stearyl stearic acid ester, N-stearyl erucic acid ester, methylene bis(stearic acid ester), ethylene bis(lauric acid ester), ethylene bis(capric acid ester), ethylene bis(oleic acid ester), ethylene bis(stearic acid ester), ethylene bis(erucic acid ester), ethylene bis(isostearic acid ester), butylene bis(stearic acid ester), and p-xylylene bis(stearic acid ester); dicarboxylic acid derivatives such as dimethyl adipate, dibutyl adipate, diisodecyl adipate, and dibutyl sebacate; cyclic compounds each having, in a molecule thereof, a functional group C═O and one or more functional groups selected from the group consisting of NH, S, and O, such indigo, quinacridone, and quinacridone magenta; as sorbitol-based derivatives such as bisbenzylidene sorbitol and bis(p-methylbenzylidene) sorbitol; compounds each containing a nitrogen-containing heteroaromatic nucleus, such as pyridine, triazine, and imidazole; phosphoric acid ester compounds, bisamides of higher fatty acids, and metal salts of higher fatty acids; branched polylactic acid; and low molecular weight poly3-hydroxybutyrate. One of these crystal nucleating agents may be used solely, or two or more of these crystal nucleating agents may be used in combination.

The present resin composition may further contain a lubricant. The lubricant is not particularly limited, but examples thereof include: fatty acid metal salts such as magnesium stearate and calcium stearate; fatty acid amides such as behenic acid amide, stearic acid amide, erucic acid amide, oleic acid amide, methylene bis(stearic acid amide), and ethylene bis(stearic acid amide); glycerol monofatty acid esters such as polyethylene wax, oxidized polyester wax, glycerol monostearate, glycerol monobehenate, and glycerol monolaurate; organic acid monoglycerides such as succinic acid saturated fatty acid monoglyceride; sorbitan fatty acid esters such as sorbitan behenate, sorbitan stearate, and sorbitan laurate; polyglycerol fatty acid esters such as diglycerol stearate, diglycerol laurate, tetraglycerol stearate, tetraglycerol laurate, decaglycerol stearate, and decaglycerol laurate; and higher alcohol fatty acid esters such as stearyl stearate. However, the lubricant is not limited to these examples. One of these lubricants may be used solely, or two or more of these lubricants may be used in combination.

The present resin composition may further contain a plasticizer. The plasticizer is not particularly limited, but examples thereof include: polyester-based plasticizers such as polypropylene glycol sebacic acid ester; aliphatic dibasic acid ester-based plasticizers such as di-1-butyl adipate, di-n-butyl sebacate, and di-2-ethylhexyl azelate; glycerol-based plasticizers such as glycerol diacetomonolaurate, glycerol diacetomonocaprylate, and glycerol diacetomonodecanoate; polyvalent carboxylic acid ester-based plasticizers such as acetyl tri-2-ethylhexyl citrate and acetyl tributyl citrate; polyalkylene glycol-based plasticizers such as polyethylene glycol, polypropylene glycol, poly(ethylene oxide·propylene oxide) block and/or random copolymers, and polytetramethylene glycol; phosphoric acid ester-based plasticizers such as diphenyl-2-ethylhexyl phosphate and diphenyl octyl phosphate; epoxy-based plasticizers such as epoxidized soybean oil fatty acid butyl ester and epoxidized linseed oil fatty acid butyl ester; and castor oil-based plasticizers such as castor oil fatty acid ester, methyl ricinoleate, ethyl ricinoleate, isopropyl ricinoleate, butyl ricinoleate, ethylene glycol monoricinoleate, propylene glycol monoricinoleate, trimethylolpropane monoricinoleate, sorbitan monoricinoleate, castor oil fatty acid polyethylene glycol esters, castor oil ethylene oxide adducts, castor oil-based polyols, castor oil-based toluols, or castor oil-based diols. One of these plasticizers may be used solely, or two or more of these plasticizers may be used in combination.

The present resin composition may further contain an organic filler. The organic filler is not particularly limited, but examples thereof include: fillers made of naturally derived materials such as wood-based materials (for example, wood chips, wood flour, sawdust, and the like), rice husks, rice flour, starch, corn starch, rice straw, wheat straw, and natural rubber; organic fibers such as vegetable natural fibers, animal natural fibers, and synthetic fibers; and fillers made of materials of synthetic resins, such as polyester, polyacrylic, polyamide, nylon, polyethylene, polyolefin, polyvinyl alcohol, polyvinyl chloride, polyurethane, polyacetal, aramid, PBO (poly-p-phenylene benzobisoxazole), polyphenylene sulfide, acetyl cellulose, polybenzazole, polyarylate, polyvinyl acetate, and synthetic rubber.

The present resin composition may further contain vegetable natural fibers. The vegetable natural fibers are not particularly limited, but examples thereof include kenaf fibers, abaca fibers, bamboo fibers, jute fibers, hemp fibers, linen fibers, henequen (sisal hemp), ramie fibers, hemp, cotton, banana fibers, coconut fibers, palm tree, palm, paper mulberry, paper bush, and bagasse. Examples of the vegetable natural fibers also include regenerated fibers obtained by processing vegetable fibers, such as pulp, cellulose fibers, and rayon. Examples of the animal natural fibers include wool, silk, cashmere, and mohair.

The present resin composition may further contain an antioxidant. The antioxidant is not particularly limited, but examples thereof include phenol-based antioxidants, phosphorus-based antioxidants, and sulfur-based antioxidants. One of these antioxidants may be used solely, or two or more of these antioxidants may be used in combination.

The present resin composition may further contain a hydrolysis inhibitor. The hydrolysis inhibitor is not particularly limited, but examples thereof include carbodiimide compounds, epoxy compounds, isocyanate compounds, and oxazoline compounds. One of these hydrolysis inhibitors may be used solely, or two or more of these hydrolysis inhibitors may be used in combination.

The present resin composition may further contain an ultraviolet absorber. The ultraviolet absorber is not particularly limited, but examples thereof include benzophenone-based compounds, benzotriazole-based compounds, triazine-based compounds, salicylic acid-based compounds, cyanoacrylate-based compounds, and nickel complex salt-based compounds. One of these ultraviolet absorbers may be used solely, or two or more of these ultraviolet absorbers may be used in combination.

The present resin composition may further contain a colorant such as a pigment or a dye. The colorant such as a pigment or a dye is not particularly limited, but examples thereof include: inorganic colorants such as titanium oxide, calcium carbonate, chromium oxide, cuprous oxide, calcium silicate, iron oxide, carbon black, graphite, titan yellow, and cobalt blue; soluble azo pigments such as lake red, lithol red, and brilliant carmine; insoluble azo pigments such as dinitrian orange and fast yellow; phthalocyanine pigments such as monochlorophthalocyanine blue, polychlorophthalocyanine blue, and polybromophthalocyanine green; condensation polycyclic pigments such as indigo blue, perylene red, isoindolinone yellow, and quinacridone red; and dyes such as oracet yellow. One of these colorants may be used solely, or two or more of these colorants may be used in combination.

The present resin composition may further contain an antistatic agent. The antistatic agent is not particularly limited, but examples thereof include low molecular antistatic agents such as fatty acid ester compounds, aliphatic ethanolamine compounds, and aliphatic ethanolamide compounds, and high molecular antistatic agents. One of these antistatic agents may be used solely, or two or more of these antistatic agents may be used in combination.

The present resin composition can also contain a catalyst deactivator (hindered phenol-based compounds, thioether-based compounds, vitamin-based compounds, triazole-based compounds, polyvalent amine-based compounds, hydrazine derivative-based compounds, phosphorus-based compounds, and the like), a mold release agent (montanic acid, salts thereof, esters thereof, half-esters thereof, stearyl alcohol, stearamide, polyethylene wax, and the like), an anti-coloring agent (phosphites, hypophosphites, and the like), a silane coupling agent (epoxysilane coupling agents, aminosilane coupling agents, (meth)acrylic silane coupling agents, isocyanate silane coupling agents, and the like), a flame retardant (red phosphorus, phosphoric acid esters, brominated polystyrene, brominated polyphenylene ether, brominated polycarbonate, aluminum hydroxide, magnesium hydroxide, melamine, cyanuric acid or salts thereof, silicon compounds, and the like), an electrically conductive agent (carbon black and the like), a slidability improving agent (graphite, fluororesin, and the like), an epoxy compound (glycidyl ether compounds, glycidyl ester compounds, high molecular compounds obtained by grafting or copolymerization of glycidyl compounds, and the like), an acid anhydride compound (maleic anhydride, succinic anhydride, high molecular compounds obtained by grafting or copolymerization of acid anhydrides, and the like), a carbodiimide compound (N,N′-di-2,6-diisopropylphenylcarbodiimide, 2,6,2′,6′-tetraisopropyldiphenylcarbodiimide, polycarbodiimide, and the like), or the like.

The content of each of the above-described components contained as another component is not particularly limited, provided that the effects of an embodiment of the present invention are brought about. The content of each of the above-described components can be set, as appropriate, by a person skilled in the art.

### 2. Method for Producing Resin Composition

In an embodiment of the present invention, provided is a method for producing a resin composition, the method including a mixing step of mixing a component (A) and a component (B). In the present specification, the “method for producing a resin composition in accordance with an embodiment of the present invention” may be referred to as “the present method for producing a resin composition”. It is possible to suitably use “the present method for producing a resin composition” as a method for producing “the present resin composition”.

The specific aspects of the component (A), the component (B), and another component used in the present method for producing a resin composition are the same as those described in the above section [3. Resin composition]. Therefore, the descriptions in that section are incorporated by reference, and the descriptions thereof are omitted in this section.

### <Mixing Step>

The present method for producing a resin composition includes a mixing step of mixing the component (A), the component (B), and, as necessary, another component. The blending amount of each component in the mixing step is the content of each component in a resulting resin composition. Therefore, in the mixing step, each component is mixed so that the content of each component in a resulting resin composition becomes a desired amount.

The mixing step is not particularly limited, provided that the mixing step is a method in which the component (A) and the component (B) are mixed. The mixing step can be carried out by a known method. The mixing step can be carried out, for example, by a method of mixing thermoplastic resins, crosslinked resin particles, optionally a crystal nucleating a agent and/or nucleating agent, and another component with use of an extruder, a kneader, a Banbury mixer, a kneading roll, or the like. The mixing step may include a melt-kneading step of melt-kneading the present crosslinked resin particles and the thermoplastic resins. In a case where melt-kneading is carried out, it is preferable to carry out mixing while paying attention to a decrease in the molecular weight of the component (A) due to pyrolysis. A resin composition can also be produced by dissolving each component in a soluble solvent and then removing the solvent.

In a case where a resin composition is produced by melt-kneading, each component may be separately introduced into an extruder or the like, or each component may be mixed in advance and then introduced into an extruder or the like.

In a case where melt-kneading is carried out by an extruder, a resulting resin composition may be processed into a particle shape such as a bar shape, a cylindrical shape, an elliptically cylindrical shape, a spherical shape, a cubic shape, or a rectangular parallelepiped shape by being cut after being extruded into a strand shape.

A resin temperature during melt-kneading cannot be unconditionally specified because the resin temperature depends on the melting points, melt viscosities, and the like of the resins used, but is preferably 140° C. to 220° C., more preferably 150° C. to 210° C., and still more preferably 160° C. to 200° C., from the viewpoint of uniformly dispersing the component (B) while avoiding pyrolysis of the component (A).

### 3. Molded Product

In an embodiment of the present invention, a molded product containing the present resin composition is provided. Hereinafter, a “molded product in accordance with an embodiment of the present invention” may be referred to as “the present molded product”. It can also be said that the present molded product is a molded product obtained by the molding present resin composition. In providing the present molded product, a method of molding the present resin composition is not particularly limited, and a generally used molding method can be applied. Specific examples of the molding method include inflation film molding, extrusion blow molding, injection blow molding, extrusion molding, calender molding, vacuum molding, and injection molding. It can also be said that the molded product obtained by molding the present resin composition is a molded product containing the present resin composition.

By carrying out the above-described molding method with use of the present resin composition, it is possible to produce, with good productivity, a molded product having excellent tensile impact strength, specifically, a sheet, a film, a blow-molded product, an extrusion-molded product, a vacuum-molded product, or an injection-molded product. In other words, the present molded product can be a sheet, a film, a blow-molded product, an extrusion-molded product, a vacuum-molded product, or an injection-molded product.

The present molded product can be suitably used in the fields of agriculture, fishery, forestry, horticulture, medicine, sanitary products, food industry, clothing, non-clothing, packaging, automobiles, building materials, and the like.

### (Impact Resistance)

The present molded product is a molded product having excellent impact resistance. In the present specification, the impact resistance of the molded product can be evaluated by a drop-weight strength test. A specific test method for the drop-weight strength test is as follows. A sheet-shaped molded product having a thickness of 700 μm is cut into a 40-mm square to prepare a measurement sample. A drop-weight test is carried out on the prepared sample with use of a DuPont-type drop impact tester (striker tip radius: 7.93 mm) with a 300-g dropping weight. A drop height is increased from 100 mm in increments of 10 mm, and the drop height at the time of occurrence of a crack or break in the sample is recorded.

The higher the drop height that is measured by the above method at the time of occurrence of a crack or break in the sample (hereinafter may be simply referred to as “drop height”) is, the more excellent impact resistance the molded product that is a measurement target has.

The drop height for the present molded product is preferably 260 mm or more, more preferably 280 mm or more, and still more preferably 300 mm or more. The drop height for the molded product being 260 mm or more means that the molded product has excellent impact resistance. A higher drop height is more preferable for the present molded product. The upper limit of the drop height is not particularly limited, but can be, for example, 500 mm or less.

### (Elastic Modulus)

The present molded product is also a molded product having an excellent elastic modulus. In the present specification, the elastic modulus of the molded product can be evaluated by an elastic modulus in tension. A specific test method for the elastic modulus in tension is as follows. A sheet-shaped molded product having a thickness of 700 μm is cut into a dumbbell shape conforming to JIS K 7127 TYPE 5 to prepare a measurement sample. A tensile test is carried out on this sample with use of a tensile testing machine (EZ-LX 1 kN, manufactured by Shimadzu Corporation) at a tensile speed of 100 mm/min in conformity with JIS K 7127. The elastic modulus in tension is calculated based on an S-S curve obtained from the tensile test.

The higher the elastic modulus in tension calculated by the above method is, the more excellent elastic modulus the molded product that is a measurement target has.

The elastic modulus in tension of the present molded product is preferably 1,500 MPa or more, more preferably 2,000 MPa or more, still more preferably 2,500 MPa or more, and even still more preferably 3,000 MPa. The elastic modulus in tension of the molded product being 1,500 MPa or more means that the molded product has an excellent elastic modulus. A higher elastic modulus in tension is more preferable for the present molded product. The upper limit of the elastic modulus in tension is not particularly limited, but can be, for example, 5,5000 MPa or less.

### 4. Others

An aspect of the present invention may include the following configurations.

<1> A resin composition containing a poly(3-hydroxyalkanoate)-based resin component (A) and inorganic particles (B), wherein the poly(3-hydroxyalkanoate)-based resin component (A) contains a poly(3-hydroxyalkanoate)-based copolymer (a-1) having a weight average molecular weight of 450,000 to 1,000,000 and a poly(3-hydroxyalkanoate)-based copolymer (a-2) having a weight average molecular weight greater by 100,000 or more than that of the poly(3-hydroxyalkanoate)-based copolymer (a-1).

<2> The resin composition described in <1>, wherein: the poly(3-hydroxyalkanoate)-based copolymer (a-2) is a copolymer of a 3-hydroxybutyrate unit and another hydroxyalkanoate unit; and a composition ratio of the 3-hydroxybutyrate unit is 77 mol % to 99 mol %.

<3> The resin composition described in <1> or <2>, wherein a content of the poly(3-hydroxyalkanoate)-based copolymer (a-1) in 100 parts by weight of the poly(3-hydroxyalkanoate)-based resin component (A) is 60 parts by weight to 99 parts by weight.

<4> The resin composition described in any one of <1> through <3>, wherein the poly(3-hydroxyalkanoate)-based copolymer (a-1) and/or the poly(3-hydroxyalkanoate)-based copolymer (a-2) is at least one selected from the group consisting of poly(3-hydroxybutyrate-co-3-hydroxyhexanoate), poly(3-hydroxybutyrate-co-4-hydroxybutyrate), poly(3-hydroxybutyrate-co-3-hydroxypropionate), poly(3-hydroxybutyrate-co-3-hydroxyvalerate), poly(3-hydroxybutyrate-co-3-hydroxyoctanoate), poly(3-hydroxybutyrate-co-3-hydroxyoctadecanoate), poly(3-hydroxybutyrate-co-3-hydroxydecanoate), and poly(3-hydroxybutyrate-co-3-hydroxyvalerate-co-3-hydroxyhexanoate).

<5> The resin composition described in any one of <1> through <4>, wherein the poly(3-hydroxyalkanoate)-based copolymer (a-1) and/or the poly(3-hydroxyalkanoate)-based copolymer (a-2) is poly(3-hydroxybutyrate-co-3-hydroxyhexanoate).

<6> The resin composition described in any one of <1> through <5>, wherein: the poly(3-hydroxyalkanoate)-based copolymer (a-1) is a copolymer of a 3-hydroxybutyrate unit and another hydroxyalkanoate unit; and a composition ratio of the 3-hydroxybutyrate unit is 77 mol % to 99 mol %.

<7> The resin composition described in any one of <1> through <6>, wherein the inorganic particles (B) are one or more selected from the group consisting of talc, mica, kaolinite, montmorillonite, and smectite.

<8> A molded product containing a resin composition described in any one of <1> through <7>.

<9> The molded product described in <8>, wherein the molded product is a sheet, a film, a blow-molded product, an extrusion-molded product, a vacuum-molded product, or an injection-molded product.

<10> The resin composition described in <2>, wherein the composition ratio of the 3-hydroxybutyrate unit is 87 mol % to 92 mol %.

### EXAMPLES

The present invention is described below in detail with reference to examples. Note, however, that these examples do not limit the technical scope of the present invention.

### Materials

The substances used in the examples and comparative examples are described below.

### (Component (A))

(A-1): Poly(3-hydroxybutyrate-co-3-hydroxyhexanoate) (P3HB3HH) which was obtained in accordance with the method disclosed in International Publication No. WO 2008/010296, in which the composition ratio of a 3-hydroxyhexanoate (3HB) unit was 94.2 mol %, and which had a weight average molecular weight of 530,000

(A-2): Poly(3-hydroxybutyrate-co-3-hydroxyhexanoate) (P3HB3HH) which was obtained in accordance with the method disclosed in International Publication No. WO 2008/010296, in which the composition ratio of a 3-hydroxyhexanoate (3HB) unit was 94.2 mol %, and which had a weight average molecular weight of 760,000

(A-3): Poly(3-hydroxybutyrate-co-3-hydroxyhexanoate) (P3HB3HH) which was produced in accordance with the method disclosed in International Publication No. WO 2013/147139, in which the composition ratio of a 3HB unit was 89.5 mol %, and which had a weight average molecular weight of 540,000

(A-4): Poly(3-hydroxybutyrate-co-3-hydroxyhexanoate) (P3HB3HH) which was produced in accordance with the method disclosed in International Publication No. WO 2013/147139, in which the composition ratio of a 3HB unit was 89.5 mol %, and which had a weight average molecular weight of 780,000

(A-5): Poly(3-hydroxybutyrate-co-3-hydroxyhexanoate) (P3HB3HH) which was produced in accordance with the method disclosed in International Publication No. WO 2013/147139, in which the composition ratio of a 3HB unit was 89.5 mol %, and which had a weight average molecular weight of 1, 300,000 Note that the gel fraction of each of P3HA (A-1) through (A-5) was 0%.

### <Measurement of Monomer Composition Ratio of Copolymer>

The monomer composition ratio of each copolymer contained in the component (A) was determined as follows. To 20 mg of a target copolymer, 1 mL of a concentrated sulfuric acid (98%)-methanol mixed solution (15:85) and 1 mL of chloroform were added. After hermetic sealing, a resulting solution was heated at 100° C. for 140 minutes to obtain a methyl ester, which was a decomposition product of the copolymer. After the methyl ester was cooled, 0.5 mL of deionized water was added to the methyl ester, and a resulting emulsion was mixed well. Subsequently, the emulsion was left to stand until an aqueous layer and an organic layer were separated. Thereafter, the monomer unit composition of the copolymer decomposition product in the collected organic layer was analyzed by capillary gas chromatography. From an obtained peak area, the monomer composition ratio in the target copolymer was calculated.

### <Measurement of Weight Average Molecular Weight>

The weight average molecular weight of each copolymer contained in the component (A) was determined as follows. First, a measurement target copolymer was dissolved in chloroform, a resulting solution was heated in a 60° C. water bath for 0.5 hours, and then a soluble content was filtered with use of a PTFE disposable filter having a pore diameter of 0.45 μm. After the filtration, GPC measurement was carried out with use of resulting filtrate under the following conditions so as to determine the value of the weight average molecular weight of the target copolymer in terms of polystyrene. GPC measurement device: High-performance liquid chromatograph 20A system manufactured by Shimadzu Corporation
Column: K-G 4A (one) and K-806M (two) manufactured by
Showa Denko K.K.
Sample concentration: 1 mg/ml
Eluent: Chloroform solution
Eluent flow rate: 1.0 ml/min
Injected sample amount: 100 μL
Analysis time: 30 minutes
Standard sample: Standard polystyrene

### (Inorganic Particles (B))

(B-1): Mica (A-21S, manufactured by Yamaguchi Mica Co., Ltd., average particle diameter: 22 μm)

(B-2): Talc (Micro Ace K-1, manufactured by Nippon Talc Co., Ltd., average particle diameter: 8 μm).

### [Evaluation Methods]

An evaluation method for each physical property carried out in the examples and the comparative examples is described below.

### <Elastic Modulus in Tension>

A sheet-shaped molded product prepared in each of the examples and the comparative examples was cut into a dumbbell shape conforming to JIS K 7127 TYPE 5 to prepare a measurement sample. A tensile test was carried out on this sample with use of a tensile testing machine (EZ-LX 1 kN, manufactured by Shimadzu Corporation) at a tensile speed of 100 mm/min in conformity with JIS K 7127. An elastic modulus in tension was calculated based on an S-S curve obtained from the tensile test.

### <Drop-Weight Strength>

The sheet-shaped molded product prepared in each of the examples and the comparative examples was cut into a 40-mm square to prepare a measurement sample. A drop-weight test was carried out on the prepared sample with use of a DuPont-type drop impact tester (striker tip radius: 7.93 mm) with a 300-g dropping weight. A drop height was increased from 100 mm in increments of 10 mm, and the drop height at the time of occurrence of a crack or break in the sample was recorded.

### Example 1

As the component (A), 90 parts by weight of (A-1) and 10 parts by weight of (A-4) and, as the component (B), 30 parts by weight of (B-1) were mixed. A resulting mixture was melt-kneaded at a rotation speed of 16 rpm for 3 minutes with use of a two-roll mill set at 145° C., and thereby a resin composition containing the above components was obtained. This resin composition was introduced into calender rolls at 130° C. to 140° C. While the resin composition was rolled, the thickness thereof was adjusted. A sheet-shaped molded product having a thickness of 700 μm was thus obtained. The elastic modulus in tension and drop-weight strength of the obtained molded product were evaluated. The results thereof are shown in Table 1. Note that, in Example 1, (A-1) corresponds to the copolymer (a-1) and (A-4) corresponds to the copolymer (a-2).

### Examples 2 to 4 and Comparative Examples 1 and 2

Resin compositions and sheet-shaped molded products were prepared in the same manner as in Example 1, except that the blending ratio of each component was changed as shown in Table 1. The elastic modulus in tension and drop-weight strength of each obtained molded product were evaluated in the same manner as in Example 1. The results thereof are shown in Table 1. Note that, in Examples 2 and 3, (A-1) corresponds to the copolymer (a-1) and (A-5) corresponds to the copolymer (a-2). Note also that, in Example 4, (A-3) corresponds to the copolymer (a-1) and (A-2) corresponds to the copolymer (a-2).

TABLE 1

| | | | | | | | Comparative | Comparative |
|---|---|---|---|---|---|---|---|---|
| | | | Example 1 | Example 2 | Example 3 | Example 4 | Example 1 | Example 2 |
| Component | (A-1) | Parts by | 90 | 90 | 95 | | 90 | 70 |
| (A) | | weight | | | | | | |
| | (A-2) | Parts by | | | | 70 | | |
| | | weight | | | | | | |
| | (A-3) | Parts by | | | | 30 | 10 | 30 |
| | | weight | | | | | | |
| | (A-4) | Parts by | 10 | | | | | |
| | | weight | | | | | | |
| | (A-5) | Parts by | | 10 | 5 | | | |
| | | weight | | | | | | |
| Component | (B-1) | Parts by | 30 | 30 | 30 | | 30 | |
| (B) | | weight | | | | | | |
| | (B-2) | Parts by | | | | 5 | | 5 |
| | | weight | | | | | | |
| Evaluation | Elastic modulus | MPa | 3450 | 3350 | 3400 | 1550 | 3200 | 1800 |
| | in tension | | | | | | | |
| | Drop-weight | mm | 260 | 300 | 280 | 410 | 220 | 250 |
| | strength | | | | | | | |

From the comparison between Examples 1 to 3 and Comparative Example 1, it is found that, by mixing (A-1) with (A-4) or (A-5), which each have a relatively high molecular weight, it is possible to provide a molded product having excellent impact resistance. It is also found that, in Examples 1 to 3, the elastic modulus of each molded product is also improved by increasing the content ratio of the copolymer (a-1). From the comparison between Example 4 and Comparative Example 2, it is found that, also by mixing (A-3) with (A-2), which has a relatively high molecular weight, it is possible to provide a product molded having excellent impact resistance. It is also found that, in Example 4, the impact resistance of the molded product is further improved by increasing the content ratio of the copolymer (a-2).

### INDUSTRIAL APPLICABILITY

An embodiment of the present invention makes it possible to provide a novel resin composition that can provide a molded product having excellent impact resistance. Therefore, it is possible to suitably use an embodiment of the present invention in the fields of agriculture, fishery, forestry, horticulture, medicine, sanitary products, food industry, clothing, non-clothing, packaging, automobiles, building materials, and the like.

1. A resin composition comprising:
a poly(3-hydroxyalkanoate)-based resin component (A), and
inorganic particles (B),
wherein the poly(3-hydroxyalkanoate)-based resin component (A) comprises
a poly(3-hydroxyalkanoate)-based copolymer (a-1) having a weight average molecular weight of from 450,000 g/mol to 1,000,000 g/mol, and
a poly(3-hydroxyalkanoate)-based copolymer (a-2) having a weight average molecular weight greater by at least 100,000 g/mol than the weight average molecular weight of the poly(3-hydroxyalkanoate)-based copolymer (a-1), and
wherein
the poly(3-hydroxyalkanoate)-based copolymer (a-2) is a copolymer of a 3-hydroxybutyrate unit and another hydroxyalkanoate unit; and
a content ratio of the 3-hydroxybutyrate unit based on all monomer repeating units in the poly(3-hydroxyalkanoate)-based copolymer (a-2) is from 77 mol % to 99 mol %.

2. (canceled)

3. The resin composition of claim 1, wherein a content of the poly(3-hydroxyalkanoate)-based copolymer (a-1) in 100 parts by weight of the poly(3-hydroxyalkanoate)-based resin component (A) is from 60 parts by weight to 99 parts by weight.

4. The resin composition of claim 1, wherein the poly(3-hydroxyalkanoate)-based copolymer (a-1) and/or the poly(3-hydroxyalkanoate)-based copolymer (a-2) is at least one selected from the group consisting of poly(3-hydroxybutyrate-co-3-hydroxyhexanoate), poly(3-hydroxybutyrate-co-4-hydroxybutyrate), poly(3-hydroxybutyrate-co-3-hydroxypropionate), poly(3-hydroxybutyrate-co-3-hydroxyvalerate), poly(3-hydroxybutyrate-co-3-hydroxyoctanoate), poly(3-hydroxybutyrate-co-3-hydroxyoctadecanoate), poly(3-hydroxybutyrate-co-3-hydroxydecanoate), and poly(3-hydroxybutyrate-co-3-hydroxyvalerate-co-3-hydroxyhexanoate).

5. The resin composition of claim 1, wherein the poly(3-hydroxyalkanoate)-based copolymer (a-1) and/or the poly(3-hydroxyalkanoate)-based copolymer (a-2) is poly(3-hydroxybutyrate-co-3-hydroxyhexanoate).

6. The resin composition of claim 1,
wherein
the poly(3-hydroxyalkanoate)-based copolymer (a-1) is a copolymer of a 3-hydroxybutyrate unit and another hydroxyalkanoate unit; and
a content ratio of the 3-hydroxybutyrate unit based on all monomer repeating units in the poly(3-hydroxyalkanoate)-based copolymer (a-1) is from 77 mol % to 99 mol %.

7. The resin composition of claim 1, wherein the inorganic particles (B) are talc, mica, kaolinite, montmorillonite, smectite, or a combination thereof.

8. A molded product comprising a resin composition of claim 1.

9. The molded product of claim 8, wherein the molded product is a sheet, a film, a blow-molded product, an extrusion-molded product, a vacuum-molded product, or an injection-molded product.

10. The resin composition of claim 1, wherein the content ratio of the 3-hydroxybutyrate unit based on all monomer repeating units in the poly(3-hydroxyalkanoate)-based copolymer (a-2) is from 87 mol % to 92 mol %.

11. The resin composition of claim 1, wherein the weight average molecular weight of the poly(3-hydroxyalkanoate)-based copolymer (a-1) is from 550,000 to 800,000 g/mol.

12. The resin composition of claim 1, wherein the weight average molecular weight of the poly(3-hydroxyalkanoate)-based copolymer (a-2) is from 550,000 to 3,000,000.

13. The resin composition of claim 1, wherein the content of the poly(3-hydroxyalkanoate)-based copolymer (a-1) in 100 parts by weight of the poly(3-hydroxyalkanoate)-based resin component (A) is from 80 parts by weight to 95 parts by weight.

14. The resin composition of claim 1, wherein a content of the poly(3-hydroxyalkanoate)-based copolymer (a-2) in 100 parts by weight of the poly(3-hydroxyalkanoate)-based resin component (A) is from 70 parts by weight to 97 parts by weight.

15. The resin composition of claim 1, wherein a gel fraction of the component (A) in the resin composition is less than 50%.

16. The resin composition of claim 1, wherein each of the copolymer (a-1) and the copolymer (a-2) contain less than 50% of a gel fraction.
